(19) United States
(12) Patent Application Publication
(10) Pub. No.: US 2008/0202336 A1
(43) Pub. Date: Aug. 28, 2008

(54) Flexible Adsorbent Bodies

(76) Inventors: Hans Hofer, Westhofen (DE); Hans-Gerhard Fritz, Uhingen (DE); Jochen Hammer, Stuttgart (DE)

Correspondence Address: William D. Bunch;W R Grace & Co.-Conn., Patent Department, 7500 Grace Drive, Columbia, MD, 21044-4098, US

(21) Appl. No.: 11/794,590

(22) PCT Filed: Dec. 27, 2005
(86) PCT No.: PCT/EP05/14072

§ 371 Date: Jun. 29, 2007

Related U.S. Application Data
(60) Provisional application No. 60/640,693, filed on Dec. 30, 2004.

(51) Int. Cl. B01D 53/02; B01J 20/26; B01J 21/16; B01J 15/00; B01J 29/04; D01D 5/12

(52) U.S. Cl. 95/90; 502/402; 502/80; 502/60; 264/210.1; 96/108; 422/164

(57) ABSTRACT

A flexible adsorbent body comprising, a thermoplastic polymer matrix and a porous adsorbing material, wherein said body possesses a flexural module of elasticity at 23° C. greater than about 10 MPa.

### BACKGROUND OF THE INVENTION

The present invention relates to a flexible adsorbing material having an advanced water adsorption capacity including at least one porous functional solid incorporated in a polymer matrix. The invention further relates to a shaped body that comprises the aforementioned adsorbing material, a method for its preparation and to its use.

Known examples of porous functional solids are zeolites, as well as other alumino-silicates with functional properties, and silica gels and silica-cogels. Functional properties mean specific and unspecific adsorption and desorption of molecules which are useful for any gas and liquid drying, enrichment or purification in a broad variety of industries such as chemical, petrochemical, gas and oil processing industries, and fruit and beverage industries. Furthermore, they are applicable as adsorbents and separating agents for analysis, preparation and drying processes in the diagnostic, pharmaceutical, cosmetic, and nutrition industries. Porous functional solids are further employed as catalysts.

When these materials are provided as powders or as pellets, which have a limited abrasion resistance and used in the form of fixed beds in bulk form on an industrial scale, dust-like abraded material obtained during operation impairs functioning of the process equipment.

U.S. Pat. No. 5,432,214 discloses a dehydrating plastics material composition comprising, inter alia, 50 wt. % to 80 wt. % of one or more thermosetting polymers and 20 to 50 wt. % of one or more dehydration agents which are preferably selected from silica gels and molecular sieves. When the polymer component of these mixtures is constituted by one or more thermosetting polymer, transformation into solid structures of various shapes, e.g. hollow cylinders or plates, is preferably performed by extrusion. A disadvantage of this filled dehydrating thermosetting material lies in the lack of polymer flexibility, which results in a polymer film or body that is extremely rigid.

WO Patent Application No. 9633108 discloses a container having desiccating abilities. The container comprises, inter alia, an insert formed from an adsorbent entrained polymer. The concentration of adsorbent entrained within the insert may exceed 75%, but typically falls within a range of 40 to 75 wt. % adsorbent to polymer. Although such concentrations are considered to be high concentrations in the field of polymeric adsorbents, the properties are still limited by the polymer matrix encapsulating the adsorbent particles being extremely rigid.

A series of US patents all to Hekal et al., e.g. U.S. Pat. No. 6,174,952 B1, U.S. Pat. No. 6,194,079 B1, and U.S. Pat. No. 6,214,255 B1, discloses monolithic compositions comprising a water-insoluble polymer, a hydrophilic agent and an absorbing material. In one embodiment, an absorbing material entrained polymer is formed which is useful in the manufacture of containers and packaging for items requiring controlled environments. When the product is solidified, the hydrophilic agent forms interconnecting channels through which a desired composition is communicable to the water-absorbing material. These materials have the disadvantage that the polymer is such that it impacts rigidity to the water absorbing material.

It is generally known in the art that desirable characteristics such as durability and resistance to breakage of blends based on organic polymers including functional solid components tend to decrease at very high concentrations of the functional solid.

Another approach is to produce shaped articles from a reaction mixture, which comprises zeolite, plasticizing agent and inorganic binders, i.e., siloxanes, as disclosed in WO 9949964. Such materials have a relatively high content of the zeolite, i.e., 40 to 90 wt. % (relative to the reaction mixtures used for the production of the shaped bodies) and exhibit good water adsorption kinetics. However, cross-linking of the silicone matrix requires a sensitive temperature control of the reaction mixture. Calcining both at too high or too low temperatures can result in an insufficient compressive strength of the shaped articles. During this drying process, inorganic bound extrudates tend to shrink by up to 15% causing problems regarding shape fidelity. In many cases, this shrinking causes breakage leading to unacceptable scrap rates. Moreover, inorganic bound extrudates are extremely inflexible.

The patent literature describes adsorbents incorporated into polymers, such as for example U.S. Pat. No. 5,384,047 (C. A. Sheckler), JP 62 201642 A (Keinoke Isono), U.S. Pat. No. 5,149,435 (H. J. Laube), WO 99 49964 A (Grace GmbH), U.S. Pat. No. 5,114,584 A (C. A. Sheckler), U.S. Pat. No. 4,433,063 (Bernstein P. et al), EP 0 119 913 A (Commisariat Energie Atomique). In all these cases, the polymer is used just to replacing inorganic binders to increase mechanical stability and/or simplify the manufacturing process. None of these patents refer to a flexible adsorbent body. U.S. Pat. No. 4,013,566 (Taylor R Daniel) describes polymeric adsorbent bodies for refrigerant fluid systems comprising of a zeolite and a two or-more component polymer system. The corresponding manufacturing process consists of several mixing and heating steps prior to shaping. After shaping the product needs to be cured. U.S. Pat. No. 6,458,187 B1 (Grace GmbH & Co. KG) describes the manufacture and usage of a shaped zeolite body including body or rod shapes, made by extrusion useful for but not limited to liquid coolant drying. In contrast to the present invention, the adsorbent bodies according to U.S. Pat. No. 6,458,187 B1 are rigid with some elasticity, but certainly not flexible. U.S. Pat. No. 6,318,115 (Kirchner et al.) describes the use of dryer bodies according to U.S. Pat. No. 6,458,187 B1 in a condenser of a refrigerator. The dryer body can directly be positioned into the condenser of a refrigerator, making a separate dryer cartridge obsolete. Note that in a standard arrangement dryer cartridges are separately manufactured and welded to the condenser. U.S. Pat. No. 4,013,566 describes an adsorbent body including a molecular sieve distributed in an aliphatic epoxy polymer matrix. This resin is not a thermoplastic material in nature but is thermosetting, resulting in an adsorbent body that is not truly flexible in nature.

None of the above-mentioned publications describe shaped bodies composed of polymers highly filled with porous functional solids that have equal water adsorption kinetics and elasticity that are acceptable for use in certain adsorbent applications requiring highly flexible adsorbent bodies.

### SUMMARY OF THE INVENTION

The present invention relates to a flexible adsorbent body that includes a thermoplastic polymer matrix and a porous solid adsorbing material, wherein the matrix material of the adsorbing body possesses a flexural modulus of elasticity at 23° C. greater than about 10 MPa. Generally, the matrix material of the flexible adsorbent body possesses a flexural modulus of elasticity at 23° C. of about 10 to about 1000 MPa, preferably a flexural modulus of elasticity at 23° C. of about 10 to about 500 MPa, more preferably a flexural modulus of elasticity at 23° C. of about 10 to about 100 MPa, and even more preferably a flexural modulus of elasticity at 23° C. of about 10 to about 70 MPa.

Generally the flexible adsorbent body possesses a moisture adsorption capacity at 25° C. and 10% relative humidity of at least 5% by weight water of the total weight of the body, and the body comprises at least 30% by weight adsorbent of the total weight of the body. Preferably, the flexible adsorbent body possesses a moisture adsorption capacity at 25° C. and 10% relative humidity of at least 10% by weight water of the total weight of the body, and the body comprises at least 70% by weight adsorbent of the total weight of the body. Generally, the matrix material of the flexible adsorbent body polymer possesses a glass transition temperature of less than about 10° C., and preferably the polymer comprises a glass transition temperature of about 0 to −60° C. Generally, the matrix material of the flexible adsorbent body polymer possesses a permeability coefficient of greater than about 1 g/m²d as a 100 micron film at 23° C., preferably the polymer possesses a permeability coefficient of greater than about 5 g/m²d as a 100 micron film at 23° C., and more preferably the polymer possesses a permeability coefficient of greater than about 10 g/m²d as a 100 micron film at 23° C. Generally, the flexible adsorbent body polymer comprises thermoplastic polymer or thermosetting polymer in a thermoplastic or cross-linked state, or of other thermoplastic polymers with property profiles as described herein, such as but not limited to polyether esters (PEE), ethylene vinyl acetates (EVA), styrene butadienes, ethylene octen polymers. Generally, the flexible adsorbent body adsorbing material may be composed of a porous functional solid as adsorbing material. Preferred functional solids are adsorbing agents, e.g., agents having adsorbing or desiccating properties that are useful for conditioning, separating or purifying gases or liquids, such as activated carbon, activated clay, silica gel, silica co-gel or aluminosilicate. Preferably, the functional solids may be composed of zeolite, and more preferably the functional solids may be composed of 3A zeolite. Generally, the adsorbing material is present in an amount of about 30 to about 85% by weight of the solid body and the polymer is present in an amount of from 70 to about 15% by weight of the body. The flexible adsorbent body cross-section may be in the form of an oval, square, rectangle, trefoil, wagon wheel, honeycomb, or film, which can be coiled, or be in any other shape as formed by molding devices, extrusion devices, etc. as generally known in the plastic processing industry. Preferred methods are extrusion, coextrusion, calendaring, injection molding, compression molding and blow molding. The flexible adsorbent body of the present invention may be utilized in an apparatus for conditioning, separation or purification of gases and liquids.

In another embodiment, the present invention includes a method of preparing a flexible adsorbent body by providing a mixture of a thermoplastic polymer matrix and a porous adsorbing material, extruding the mixture to form a adsorbent body; cutting the body into desired sizes, or coiling the body. Any or all of the steps through may be performed in a moisture free environment. The mixture may be prepared using a concentrated adsorbent-polymer master batch, which is subsequently diluted by the addition of pure polymer. The mixture of polymer and adsorbent is prepared by the use of a single-screw or a co-rotating twin-screw extruder, equipped with an adequate extrusion die to mold the flexible extrudates.

Another embodiment of the present invention relates to an apparatus for conditioning, separating or purifying gases and liquids including a flexible adsorbent body and a housing member, wherein the housing member includes bent portions comprising the flexible adsorbent body. The apparatus may include refrigeration devices, chillers or climate systems. The housing member may include the circuit of a cooling system, more specifically condenser or evaporator tubes. The flexible adsorbent body may be inserted into the housing member prior to or subsequent to formation of the bent portions.

A further embodiment of the present invention regards a method of ° fabricating an apparatus for conditioning, separating or purifying gases and liquids by providing a flexible adsorbent body; providing a housing member to hold the flexible adsorbent body; and modifying the shape of housing member to form bent portions. The flexible adsorbent body may be inserted into the housing member prior or subsequent to formation of the bent portions. The apparatus may include refrigeration devices, chillers or climate systems. The housing member may include the circuit of a cooling system, more specifically condenser or evaporator tubes.

### BRIEF DESCRIPTION OF DRAWINGS

FIG. 1 is a graphical representation of viscosity versus shear rate of a polymer matrix material of the present flexible desiccant body at three different temperatures.

FIG. 2 is a graphical representation of water adsorption kinetics for a dryer bar of the present invention.

FIG. 3 is a graphical representation of water adsorption kinetics for a monolith of the present invention.

FIG. 4 is a graphical representation of water adsorption kinetics for a film of the present invention.

FIG. 5 is a graphical representation of water adsorption kinetics for a film of the present invention.

### DETAILED DESCRIPTION OF PREFERRED EMBODIMENTS

The present invention comprises the formulation and the manufacturing of a flexible adsorbent body including an adsorbing material, which is incorporated into a flexible polymer matrix. The flexible adsorbent may be used for gas and liquid drying, and various industrial separation and purification processes including in the non-regenerative mode (i.e., no regeneration of the adsorbent during use), such as liquid coolant drying in refrigeration and climate systems.

Furthermore, the flexible adsorbent body of the present invention in combination with an appropriate packaging device may be useful for the protection of delicate goods from moisture in non-permanently and permanently packed products. For example, such packaging devices may house nutrition or food, pharmaceuticals, diagnostics, cosmetics, electronics, optics, opto-electronics, as well as micro- and nano-mechanical components, such as for example, as desiccants and moisture scavengers in drug bottles and containers, and boxes and cartridges to store diagnostics and spent diagnostics, and to store spent diagnostics prior to discharge, where the adsorbing flexible desiccant body is placed into or attached to the bottles and containers, and boxes and cartridges, or is an integral part of them. The flexible adsorbent body may be especially useful as a replacement of dryer cartridges and rigid dryer bodies that may be directly filled into the condenser tube of a chilling device. In contrast to the use of separate dryer cartridges or rigid dryer bodies used in current devices, flexible adsorbent bodies of the present invention may be coiled after extrusion, stored as coils, wound up and directly fed into the condenser assembling line. The flexible adsorbent body may be cut to the appropriate length and may be fed in one piece into the condenser tube prior to or after forming, shaping or bending.

In one embodiment, the present invention relates to a flexible adsorbent body that includes a thermoplastic polymer matrix and a porous solid adsorbing material, wherein the body possesses a modulus of elasticity at 23° C. greater than about 10 MPa. Generally, the flexible adsorbent body possesses a modulus of elasticity at 23° C. of about 10 to about 1000 MPa, preferably a modulus of elasticity at 23° C. of about 10 to about 500 MPa, more preferably a modulus of elasticity at 23° C. of about 10 to about 100 MPa, and even more preferably a modulus of elasticity at 23° C. of about 10 to about 70 MPa. Generally the flexible adsorbent body possesses a moisture adsorption capacity at 25° C. and 10% relative humidity of at least 5% by weight water of the total weight of the body, and the body comprises at least 30% by weight adsorbent of the total weight of the body. Preferably, the flexible adsorbent body possesses a moisture adsorption capacity at 25° C. and 10% relative humidity of at least 10% by weight water of the total weight of the body, and the body comprises at least 70% by weight adsorbent of the total weight of the body. The flexible adsorbent body possesses a water pick-up rate from about 0.001 wt %/hour at 10% relative humidity to about 40.0 wt %/hour at 80% relative humidity. Generally, the flexible adsorbent body polymer possesses a glass transition temperature of less than about 10° C., and preferably the polymer comprises a glass transition temperature of about 0 to −60° C. Generally, the flexible adsorbent body polymer possesses a permeability coefficient of greater than about 1 g/m²d as a 100 micron film at 23° C., preferably the polymer possesses a permeability coefficient of greater than about 5 g/m²d as a 100 micron film at 23° C., and more preferably the polymer possesses a permeability coefficient of greater than about 10 g/m²d as a 100 micron film at 23° C. Generally, the flexible adsorbent body polymer comprises thermoplastic polymer, an elastomer, or a thermosetting polymer in a thermoplastic or cross-linked state, or of other thermoplastic polymers with property profiles as described herein, such as but not limited to polyether esters (PEE), ethylene vinyl acetates (EVA), styrene butadienes, ethylene octen polymers. Generally, the flexible adsorbent body adsorbing material may be composed of a porous functional solid. Preferred functional solids are adsorbing agents, e.g., agents having adsorbing or desiccating properties that are useful for conditioning, separating or purifying gases or liquids, which include amorphous and crystalline inorganic oxides, alkaline (Me+) and earth alkaline (Me2+) aluminum silicates, solid solutions thereof, Me+ and Me2+ aluminum silicates, wherein the Me+ and Me2+ are partly substituted with any suitable metal ion selected from transition elements, elements of the groups IIIA, IVA, VA and VIA of the periodic table and any combination thereof, solid solutions thereof, aluminum phosphates, Me+ and Me2+ aluminum phosphates, solid solutions thereof, Me+ and Me2+ aluminum phosphates, wherein Me+ and Me2+ are partly substituted with any suitable metal ion selected from transition elements, elements of the groups IIIA, IVA, VA and VIA of the periodic table and any combination thereof, solid solutions thereof, activated carbon and any combination of the aforementioned types of adsorbing agents. It is further preferred that the adsorbing agents include framework silicates (as disclosed in Deel; Howie & Zussman, The Rock Forming Minerals, 2fld Edition, Longman Scientific & Technical, Harlow, Essex, England, 1993), compositions with structures iso-type, respectively, iso-morphous to the aforementioned framework silicates, fly ash, pillared layered clays, amorphous and crystalline aluminum phosphates, silica gels, silica cogels, amorphous alumina, amorphous titania, amorphous zirconia, activated carbon, and any combination thereof, but zeolites of the groups 1, 2, 3, 4, 5, 6 and 7 (according to Donald W Breck, Zeolite Molecular Sieves, Robert E. Kregel; Publishing CoMPany; Malabal; Fla., 1984), compositions with structures iso-type, respectively, iso-morphous to the aforementioned types of zeolites, silica gels, silica cogels and any combination thereof are particularly preferred. The term “iso-type” and “iso-morphous” respectively are defined in R. C. Evans, An Introduction to Crystal Chemist˜2fld Edition, Cambridge University Press, London, 1966. Among the crystalline inorganic oxides, zeolites of the groups 1, 2, 3, 4, 5, 6 and 7, compositions with structures iso-type, respectively, iso-morphous to the aforementioned types of zeolites or any mixture of these are preferred. Even more preferred examples of the aforementioned types of zeolites include members of the zeolite A family (e.g. 3A, 4A, 5A), zeolite X family, zeolite Y family (e.g. USY ultra stable Y, DAY de-aluminated Y), zeolite ZSM-5 including pure and doped Silicalite, Chabazite, ZSM-11, MCM-22, MCM-41, members of the aluminum phosphate family, compositions with structures iso-type, respectively, iso-morphous to the aforementioned types of zeolites, and any combination of these. Members of the zeolite families A, X and Y are most preferred. Generally, the flexible adsorbent body adsorbing material is present in an amount of about 30 to about 85% by weight of the solid body and the polymer is present in an amount of from 70 to about 15% by weight of the body. The flexible adsorbent body cross-section may be in the form of an oval, square, rectangle, trefoil, wagon wheel, honeycomb, or film, which can be coiled, or be in any other shape as formed by forming devices as generally known in the plastic processing industry. Preferred methods are coextrusion, calendaring, injection molding, compression molding and blow molding. The flexible adsorbent body of the present invention may be utilized in an apparatus for conditioning, separation or purification of gases and liquids.

The polymers suitable for use in the present invention possess the following physical parameters:

| | |
|---|---|
| Long-term service temperature T_{LST}: | 40° C. ≦ T_{LST} ≦ 120° C. |
| | and preferred |
| | 60° C. ≦ T_{LST} ≦ 100° C. |
| Flexural modulus of elasticity at 23° C.: | 10-1000 Mpa |
| | and preferred 10-70 MPa |
| Glass transition temperature: | <10° C. |
| | and preferred <−30° C. |
| Water permeability coefficient of the | 1-500 g/m²d |
| polymer as film (100 μm, 23° C.): | and preferred >20 g/m²d |

Examples for polymers with the aforementioned properties are:

Hytrel G3548L (PEE), EVATANE 28-40 (EVA, only in a cross-linked state)—(HOW DO YOU DO THIS?) Styroflex (styrene butadiene copolymer) Engage EG 8200 (ethylene octen copolymer, only in a cross-linked state).

In another embodiment, the present invention includes a method of preparing a flexible adsorbent body by providing a mixture of a thermoplastic or thermosetting polymer matrix and a porous solid adsorbent, extruding the mixture to form a adsorbent body, cutting the body into desired sizes, or coiling the body. Any or all of the steps through may be performed in a dry or moisture free environment or atmosphere (i.e., in an atmosphere having a dewpoint of −40° C.). The mixture may be prepared using a concentrated adsorbent-polymer master batch, which is subsequently diluted by the addition of unfilled polymer. The flexible adsorbent body cross-section may be in the shape of a round, oval, square, rectangle, trefoil, star-shaped, wagon wheel, honeycomb, or film, which can be coiled, or be in any other shape as formed by molding devices, extrusion devices, etc., as generally known in the plastic processing industry. Preferred methods are extrusion, co-extrusion, calendering, injection molding, compression molding and blow molding. The polymer matrix of the flexible adsorbent body may possess a modulus of elasticity at 23° C. of about 10 to about 1000 MPa. The flexible adsorbent body may possess a moisture adsorption capacity at 25° C. and 10% relative humidity of at least 5% by weight water of the total weight of the body, and the body may include at least 30% by weight adsorbent of the total weight of the body. The flexible adsorbent body polymer may possess a permeability coefficient of greater than about 1 g/m²d as a 100-micron film at 23° C. The flexible adsorbent body polymer may be composed of HYTREL G3548L (PEE, polyether ester), EVATANE 28-40 (EVA ethylene vinyl acetate, only in a cross-linked state), Styroflex (styrene butadiene copolymer) Engage EG 8200 (ethylene octen copolymer) in a thermoplastic or cross-linked state, or of other thermoplastic polymers with property profiles described above. The desiccant of the flexible adsorbent body solid adsorbent may include activated carbon, activated clay, silica gel, silica cogel, zeolites of the groups 1, 2, 3, 4, 5, 6 and 7, including compositions with structures that are iso-type, such as iso-morphous forms of the aforementioned types of zeolites, silica gels, silica cogels and any combination thereof. The desiccant of the flexible adsorbent body may be present in an amount of about 30 to about 85% by weight of the solid body and the polymer may be present in an amount of from about 70 to about 15% by weight of the body.

The aforementioned body may be produced by means of a single-stage or a two-stage process. The single-stage process may be a combination of compounding and moulding in a single machine. In contrast, in the two-stage process compounding and moulding are sequentially and independently executed using separate equipment.

In an embodiment relating to a single-stage process of the present invention, the compounding process may be carried out by means of a co-, or counter-rotating twin-screw extruder. The adsorption material may be activated prior to mixing with the polymer by heating the adsorption material to a temperature (e.g., 600° C. or above) and a length of time sufficient to provide a material that has a residual moisture content of about 2 wt % or less. Preferably, formulation components are processed in a dry environment (i.e., in an atmosphere having a dewpoint of −40° C.). This is especially preferable for the adsorption material. The polymer pellets may be fed into the compounding extruder system and melted. The desiccant or adsorbent material may be added to the polymer melt in a downstream section of the extruder by means of a side stream feeder. When both materials are well homogenised in the mixing zone, the compound preparation is completed, and the two-phase material may be shaped into a body by means of a single-hole or multi-hole die. In this single-stage process, mixing, compounding and body shaping may be carried out in an extruder system with dedicated sections for each process step.

In an embodiment for a two-stage process according to the present invention, mixing and compounding may be carried out in a compounder extruder system forming pellets as an intermediate product, which may be processed later on in a second extruder (single-or twin screw extruder) with an appropriate die for body extrusion.

Production and packaging of the body according to the present invention may be carried out in a dry environment (i.e., in an atmosphere having a dewpoint of −40° C.). Packaging of the body may be watertight in order to keep the body activated during storage and transportation prior to further processing. Depending on the geometrical dimensions of the body and the corresponding flexural properties, the finished flexible body may be coiled up.

Depending on the die used for the extrusion step, the body may be of round, squared, rectangle, trefoil, wagon wheel or any other shaped cross section. Furthermore, the body may be tubular. When used in tube form, any deviation from a round cross section may result in less equilibrium capacity but increased water pick-up kinetics.

In another embodiment the aforementioned body may have a honeycomb structure. The flexible dryer body with honeycomb structure may also be manufactured by means of employing a single-stage or a two-stage process. The corresponding equipment may be identical to that as used for the production of the solid body, except for shape and configuration of the die. To produce flexible drier bodies with honeycomb structures, suitable dies provide extruding arrays of channels separated by a system of walls. In both embodiments, the single-step and the two-step processes, the melt distribution systems may be readily adjusted to accommodate the rheological properties of the highly filled zeolitic adsorbent and polymer mixtures. The production and packaging of flexible adsorbent bodies having honeycomb structures may preferably be carried out in a dry environment (i.e., at a dewpoint of −40° C.). Furthermore, the packaging of the honeycomb structures may preferably be watertight in order to maintain the honeycomb structures in the activated state during storage and transportation prior to further processing.

Furthermore, flexible adsorbent bodies in the shape of flat thin films can be made by flat film extrusion and flat film co-extrusion. When two or more extruders are working on a multi-layer die, it is possible to manufacture double- or multi-layer films where each film might have different features such as water adsorption properties (adsorbing effect) and water blocking properties (moisture barrier effect) and can be coated on any substrate, such as aluminium foil or a paperboard. This can be realized by either a single stage process or a two-stage process employing single and/or twin-screw extruders. In the first case, compounding and shaping are linked together to a single stage process. Co-extrusion may be carried out by means of a co-extrusion flat body die or a co-extrusion film die. Each layer may be formed using a separate extruder. Co-extruded flexible film of the present invention used for protecting delicate goods may be in the form of bags, flexible boxes and other types of flexible containers to be filled with such goods and subsequently sealed.

Another option for preparing single-layer and multi-layer films is film blowing, whereas for the latter case at least one film layer exhibits adsorbent properties and at least one other film layer a different feature such as water blocking or moisture impermeability.

Another option for the making of flexible adsorbent bodies of almost arbitrary shape is injection moulding. This can be done in a two stage process where compounding and injection moulding is executed in sequence with a compounder (twin-screw extruder) and an injection moulding device. A single stage process is also possible where compounding and injection moulding is executed by using an injection moulding compounder.

Another embodiment of the present invention relates to an apparatus for conditioning, separating or purifying gases and liquids including a flexible adsorbent body and a housing member, wherein the housing member includes bent portions comprising the flexible adsorbent body. The body cross section may be in the shape of a round, oval, square, rectangle, trefoil, wagon wheel, honeycomb, or film, which can be coiled, or be in any other shape as formed by forming devices as generally known in the plastic processing industry. Preferred methods are extrusion, co-extrusion, calendaring, injection molding, compression molding and blow molding. The body may possess a flexural modulus of elasticity at 23° C. of about 10 to about 1000 MPa. The moisture adsorption capacity of the body at 25° C. and 10% relative humidity may be at least 5% by weight water of the total weight of the body, and the body may be at least 30% by weight adsorbent of the total weight of the body. The polymer may possess a permeability coefficient of greater than about 1 g/m²d as a 100 micron film at 23° C., and may be composed of polymer such as but not limited to HYTREL G3548L (PEE, polyether ester), EVATANE 28-40 (EVA ethylene vinyl acetate), Styroflex (styrene butadiene copolymer) cross-linked Engage EG 8200 (ethylene octen copolymer) in a thermoplastic or cross-linked state, or of other thermoplastic polymers with property profiles described above. The solid adsorbent may include activated carbon, activated clay, silica gel, silica cogel, zeolites and zeolites of the groups 1, 2, 3, 4, 5, 6 and 7, including compositions with structures that are iso-type, such as iso-morphous forms of the aforementioned types of zeolites, silica gels, silica cogels and any combination thereof. The solid adsorbent may be present in an amount of about 30 to about 75% by weight of the solid body and the polymer may be present in an amount of from 70 to about 25% by weight of the body. The apparatus may include refrigeration devices, chillers or climate systems. The housing member may include the circuit of a cooling system, more specifically condenser or evaporator tubes. The flexible adsorbent body may be inserted into the housing member prior or subsequent to formation of the bent portions.

A further embodiment of the present invention regards a method of fabricating an apparatus for conditioning, separating or purifying gases and liquids by providing a flexible adsorbent body, providing a housing member to hold the flexible adsorbent body; and modifying the shape of housing member to form bent portions. The flexible adsorbent body may be inserted into the housing member prior or subsequent to formation of the bent portions. The apparatus may be a refrigeration device, chiller or climate system, and the housing member may be a circuit of a cooling system, more specifically condenser or evaporator tubes. The body cross-section may be in the shape of a round, oval, square, rectangle, trefoil, wagon wheel, honeycomb, or film (multi-layer films), which can be coiled, or be in any other shape as formed by forming devices as generally known in the plastic processing industry. Preferred methods are extrusion, injection molding and blow molding. The flexural modulus of elasticity at 23° C. may be about 10 to about 1000 MPa. The moisture adsorption capacity of the body at 25° C. and 10% relative humidity may be at least 5% by weight water of the total weight of the body, and the body may be at least 30% by weight adsorbent of the total weight of the body. The polymer may possess a permeability coefficient of greater than about 1 g/m²d as a 100 micron film at 23° C., and the polymer may be HYTREL G3548L (PEE, polyether ester), EVATANE 28-40 (EVA ethylene vinyl acetate), Styroflex (styrene butadiene copolymer) Engage EG 8200 (ethylene octen copolymer) in a thermoplastic or cross-linked state, or of other thermoplastic polymers with property profiles described above. The solid adsorbent may be activated carbon, activated clay, silica gel, silica cogel, zeolites of the groups 1, 2, 3, 4, 5, 6 and 7, including compositions with structures that are iso-type, such as iso-morphous forms of the aforementioned types of zeolites, silica gels, silica cogels and any combination thereof. The solid adsorbent may be present in an amount of about 30 to about 75% by weight of the solid body and the polymer may be present in an amount of from 70 to about 25% by weight of the body.

A further embodiment of the present invention regards a method of equipping an apparatus for housing delicate, moisture sensitive products such as electronics, opto-electronics, opto-mechanical, as well as micro- and nano-mechanical devices with a flexible adsorbent body. The flexible adsorbent body may be inserted into the housing member or become integral part of the housing. The flexible adsorbent body may be utilized to protect pharmaceuticals, nutriceuticals, biological samples, living organisms, foods and other perishable or moisture sensitive products. The flexible adsorbent body may be used as part of the package or placed within the package. The body cross-section may be in the shape of a round, oval, square, rectangle, trefoil, wagon wheel, honeycomb, or film, also multi-layer film, which can be coiled, or be in any other shape as formed by forming devices as generally known in the plastic processing industry. Preferred methods are extrusion, co-extrusion, calendaring, injection molding, compression molding and blow molding. The flexural modulus of elasticity at 23° C. may be about 10 to about 1000 MPa. The moisture adsorption capacity of the body at 25° C. and 10% relative humidity may be at least 5% by weight water of the total weight of the body, and the body may be at least 30% by weight adsorbent of the total weight of the body. The polymer may possess a permeability coefficient of greater than about 1 g/m²d as a 100 micron film at 23° C., and the polymer may be HYTREL G3548L (PEE, polyether ester), EVATANE 28-40 (EVA ethylene vinyl acetate), Styroflex (styrene butadiene copolymer) Engage EG 8200 (ethylene octen copolymer) in a thermoplastic or cross-linked state, or of other thermoplastic polymers with property profiles described above. The solid adsorbent may be activated carbon, activated clay, silica gel, silica cogel, zeolites of the groups 1, 2, 3, 4, 5, 6 and 7, including compositions with structures that are iso-type, such as iso-morphous forms of the aforementioned types of zeolites, silica gels, silica cogels and any combination thereof. The solid adsorbent may be present in an amount of about 30 to about 75% by weight of the solid body and the polymer may be present in an amount of from 70 to about 25% by weight of the body.

The entire subject matter of all patents and publications listed in the present application are incorporated herein by reference. The following Examples are given as specific illustrations of the claimed invention. It should be understood, however, that the invention is not limited to the specific details set forth in the Examples. All parts and percentages in the Examples, as well as in the remainder of the specification, are by weight unless otherwise specified.

Furthermore, any range of numbers recited in the specification or claims, such as that representing a particular set of properties, conditions, physical states or percentages, is intended to literally incorporate expressly herein any number flowing within such range, including any subset of numbers with any range so recited. Any modifications of the invention, in addition to those shown and described herein, will become apparent to those skilled in the art from the foregoing description and accompanying drawings. Such modifications are intended to fall within the scope of the appended claims.

### Example 1

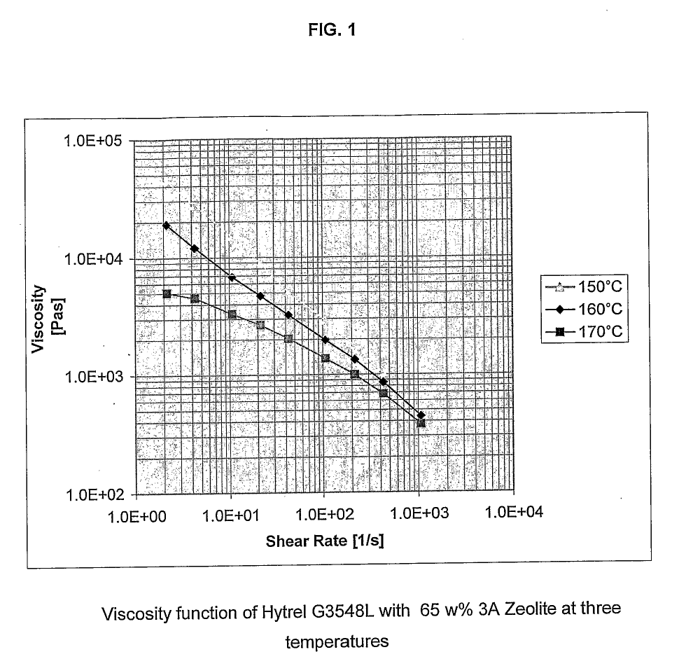

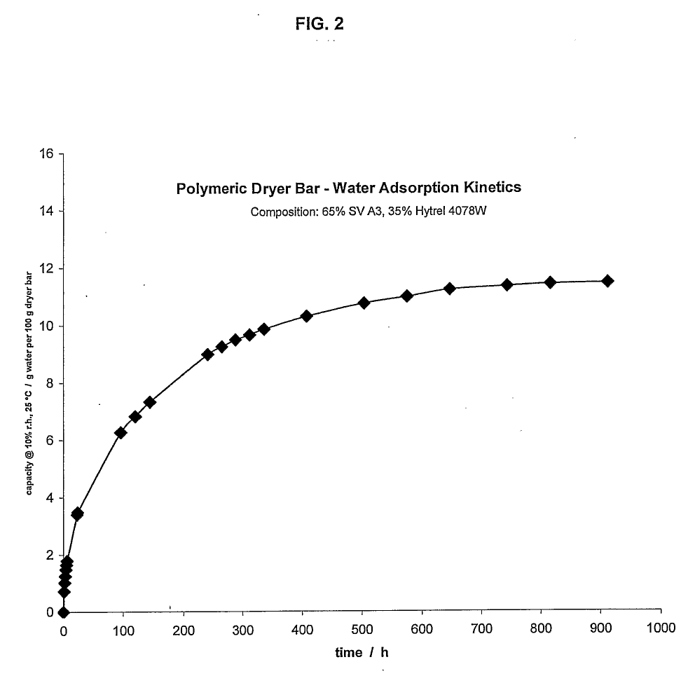

This example relates to the production of a flexible adsorbent body with a diameter of 3 mm. As matrix polymer the PEE-type Hytrel G3548L, available from E.I. DuPont De Nemours & Co. is used. For the adsorption material, a 3A zeolite available from W. R. Grace & Co.-Conn. is utilized. The compound is composed of 35 wt. % Hytrel G3548L and 65 wt. % activated zeolite 3A. The production of the body is carried out in a two-stage process with a separate compounding and moulding procedure. The compounding is performed by means of a co-rotating twin-screw-extruder, type ZSK25 available from Coperion Werner & Pfleiderer. The compounding temperature is 200° C. Moulding directly takes place after the compounding step by means of a single-screw-extruder available from Coperion Werner & Pfleiderer with a 3 mm round extrusion die. The moulding temperature is in the range of 150° C. to 155° C. The extruded body is drawn down by take off rolls and afterwards coiled. After coiling, the spools were packed in waterproof containers. The corresponding rheological data are set forth in FIG. 1 and the adsorption performance data are given in FIG. 2.

### Example 2

This example regards the production of a round zeolitic honeycomb structured adsorbing body with 27.5 mm diameter and 25 mm length. The channel geometry is 1.2×1.2 mm² and wall thickness 1.6 mm. As matrix polymer the PEE-type Hytrel G5544, available from DuPont is used. The adsorption material is a 3A zeolite available from W. R. Grace & Co.-Conn. The compound consists of 30 wt. % Hytrel G5544 and 70 wt. % activated zeolite 3A based on the total weight of the adsorbing body. These compound components are processed in dry state of form. The production of the honeycomb-structured pieces is carried out in a single stage process. The compounding and moulding is performed by means of a co-rotating twin-screw-extruder, type ZSK25 from Coperion Werner & Pfleiderer. The compounding temperature is 230-240° C. Moulding directly takes place after the compounding step by means of a die allowing to shape honeycomb structures. The temperature of this die is set to be 218-223° C. The extruded honeycomb structured piece is cooled down and cut to the desired piece size. After moulding and cutting, the honeycomb structured pieces are packed into waterproof containers. All process steps are carried out in dry atmosphere (i.e., at a dewpoint of −40° C.).

### Example 3

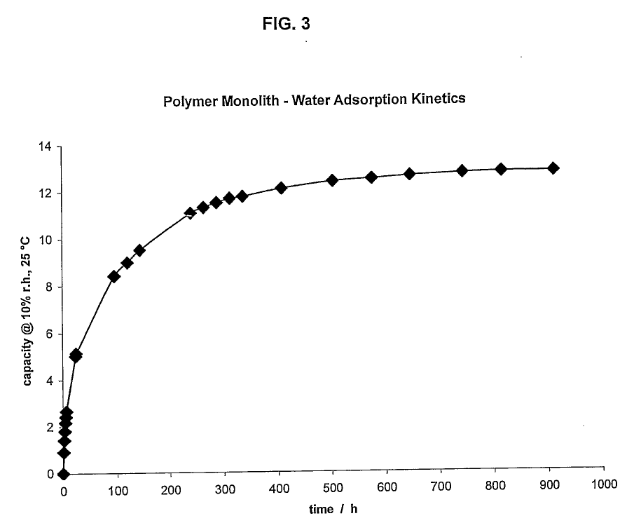

This example relates to the production of a round zeolitic honeycomb structured adsorbing body with 27.5 mm diameter and 25 mm length. The channel geometry is 1.2.×1.2 mm² and wall thickness 1.0 mm. As matrix polymer the PEE-type Hytrel G5544, from E. I. DuPont is used. The adsorption material is a 3A zeolite from Grace. The compound comprises 30 wt. % Hytrel G5544 and 70 wt. % activated zeolite 3A. These compound components are processed in dry state or form. The production of the honeycomb-structured pieces is carried out in a two-stage process. Step one: Compounding is conducted with a twin-screw extruder referenced in Example 1 at temperatures between 230-240° C., subsequently cooled down and shaped into granulates. Step two: Starting from the granulates moulding takes place by means of a die useful for shaping honeycomb structured pieces attached to a single screw extruder referenced in Example 1. The temperature of this die is set to be 218-223° C. The extruded honeycomb structured piece is cooled down and cut into the desired piece length. After moulding and cutting, the honeycomb-structured pieces are packed into waterproof containers. All process steps are carried out in dry atmosphere (i.e., at a dewpoint of −40° C.). The adsorption characteristics are given in the FIG. 3.

### Example 4

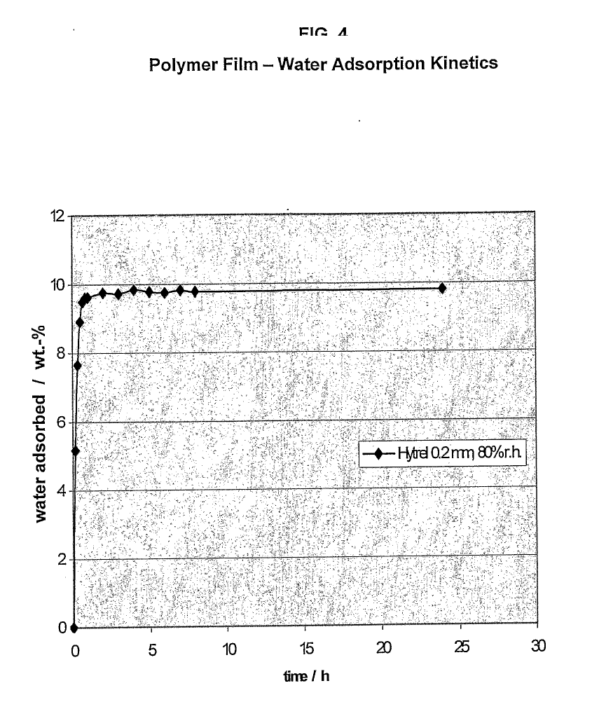

This example regards production of a flexible zeolitic film with 0.25 mm film thickness. As matrix polymer PEE-type HYTREL G3548L, available from DuPont is used. The adsorption material is a 3A zeolite available from Grace. The compound comprises 50 wt. % HYTREL G3548L and 50 wt. % activated zeolite 3A. The production of the film is carried out in a two-stage process with a separate compounding and moulding procedure. The compounding is realized by means of a co-rotating twin-screw-extruder, type ZSK25 with UD equals 40 available from Coperion Werner & Pfleiderer. The compounding temperature is 200° C. Moulding directly takes place after the compounding step by means of a single-screw-extruder available from Coperion Werner & Pfleiderer with a 100 mm flat film extrusion die (0.5 mm gap width). The moulding temperature is in the range of 150° C. to 155° C. The extruded film is drawn down by take off rolls and afterwards cut to the demanded sheet size. The drawing velocity of the take off rolls adjusts the film thickness and width. After moulding and cutting, the films are packed in waterproof containers. The adsorption characteristics are given in the FIG. 4.

### Example 5

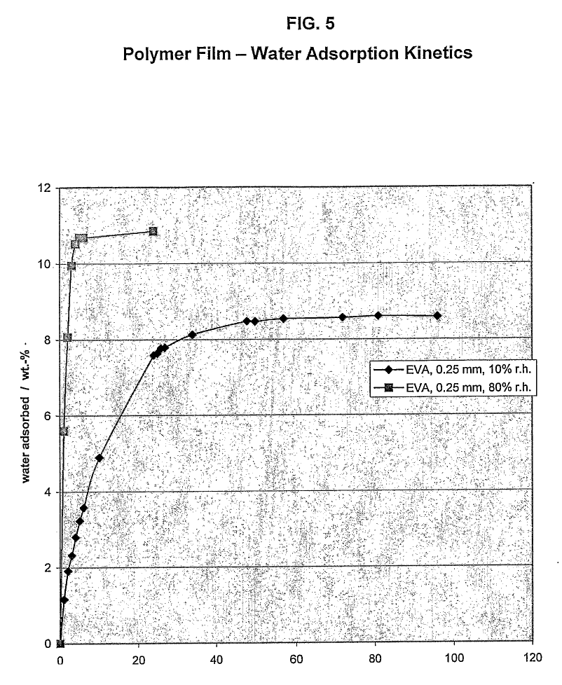

This example relates to production of a flexible zeolitic film with a film thickness of 0.25 mm. As matrix polymer EVA, type EVATANE 28-40, available from Atofina is used. The adsorption material is a 3A zeolite available from Grace. The compound includes 50 wt. % EVATANE 28-40 and 50 wt. % activated zeolite 3A. The production of the films is carried out in a separate compounding and moulding process (two-stage process). The compounding is realized by means of a co-rotating twin-screw-extruder ZSK25 with L/D equals 40 available from Coperion Werner & Pfleiderer. The compounding temperature is 150° C. Moulding directly takes place after the compounding step by means of a single-screw-extruder available from Coperion Werner & Pfleiderer with a 100 mm flat film extrusion die (0.5 mm gap width). The moulding temperature is in a range of 130 to 140° C. The extruded film is drawn down by take off rolls and afterwards cut to the demanded sheet size. The drawing velocity of the take off rolls adjusts the film thickness and width. After moulding and cutting, the films are packed in waterproof containers. The adsorption characteristics are given in the FIG. 5.

1. A flexible adsorbent body comprising,
(a) a thermoplastic polymer matrix; and
(b) a porous adsorbing material
wherein said body possesses a flexural modulus of elasticity at 23° C. greater than about 10 MPa.

2. A flexible adsorbent body according to claim 1, wherein said flexural modulus of elasticity at 23° C. is about 10 to about 1000 MPa.

3. A flexible adsorbent body according to claim 1, wherein said flexural modulus of elasticity at 23° C. is about 10 to about 500 MPa.

4. A flexible adsorbent body according to claim 1, wherein said flexural modulus of elasticity at 23° C. is about 10 to about 100 MPa.

5. A flexible adsorbent body according to claim 1, wherein moisture adsorption capacity of said body at 25° C. and 10% relative humidity comprises at least about 5% by weight water and at least about 30% by weight of said adsorbing material of the total weight of said body.

6. A flexible adsorbent body according to claim 1, wherein moisture adsorption capacity of said body at 25° C. and 10% relative humidity comprises at least about 10% by weight water and at least about 50% by weight of said adsorbing material of the total weight of said body.

7. A flexible adsorbent body according to claim 1, wherein said polymer possesses a long-term service temperature in the range of about 40 to about 120° C.

8. A flexible adsorbent body according to claim 1, wherein said polymer comprises a glass transition temperature of less than about 10° C.

9. A flexible adsorbent body according to claim 1, wherein said polymer comprises a glass transition temperature of less than about −30° C.

10. A flexible adsorbent body according to claim 1, wherein said polymer comprises a permeability coefficient of greater than about 1 g/m²d as a 100 micron film at 23° C.

11. A flexible adsorbent body according to claim 1, wherein said polymer comprises a permeability coefficient of greater than about 5 g/m²d as a 100 micron film at 23° C.

12. A flexible adsorbent body according to claim 1, wherein said polymer comprises a permeability coefficient of greater than about 10 g/m²d as a 100 micron film at 23° C.

13. A flexible adsorbent body according to claim 1, wherein said polymer comprises one or more of thermoplastic polymer or thermosetting polymer in a thermoplastic or cross linked matrix.

14. A flexible adsorbent body according to claim 1, wherein said polymer comprises at least one of polyether ester, ethylene vinyl acetate, styrene butadiene or ethylene octen polymers.

15. A flexible adsorbent body according to claim 1, wherein said adsorbing material comprises activated carbon, activated clay, silica gel, silica co-gel, molecular sieve, or combinations thereof.

16. A flexible adsorbent body according to claim 15, wherein said molecular sieve comprises zeolite.

17. A flexible adsorbent body according to claim 15, wherein said molecular sieve comprises zeolite of the groups 1, 2, 3, 4, 5, 6 and of the A, X and Y families.

17. A flexible adsorbent body according to claim 1, wherein said adsorbing material is present in an amount of about 30 to about 85% and said polymer is present in an amount of from 70 to about 15% by weight of said body.

18. A flexible adsorbent body according to claim 1, wherein said body is solid or hollow and comprises a cross-section of an oval, square, rectangle, trefoil, wagon wheel, honeycomb or film.

19. An apparatus for conditioning, separation or purification of gases and liquids comprising, a flexible adsorbent body according to claim 1.

20. A method of preparing a flexible adsorbent body comprising:
(a) providing a mixture comprising a thermoplastic polymer matrix and a porous adsorbing material;
(b) extruding said mixture to form a adsorbent body;
(c) cutting said body; and
(d) bending said body.

21. A method of preparing a flexible adsorbent body according to claim 20, wherein at least one of steps (a) through (d) are performed in a dry environment.

22. A method of preparing a flexible adsorbent body according to claim 20, wherein at least one of (a)-(c) is performed using an extruder.

23. A method of preparing a flexible adsorbent body according to claim 20, wherein said mixture is prepared using a concentrated adsorbent polymer master batch, which is subsequently diluted by addition of unfilled polymer.

24. A method of preparing a flexible adsorbent body according to claim 20, wherein said body is solid or hollow and comprises a cross-section of an oval, square, rectangle, trefoil, wagon wheel, honeycomb, or film.

25. A method of preparing a flexible adsorbent body according to claim 20, wherein said flexural modulus of elasticity at 23° C. is about 10 to about 1000 MPa.

26. A method of preparing a flexible adsorbent body according to claim 20, wherein moisture adsorption capacity of said body at 25° C. and 10% relative humidity comprises at least about 5% by weight water and at least about 30% by weight of said adsorbing material of the total weight of said body.

27. A method of preparing a flexible adsorbent body according to claim 20, wherein said polymer comprises a permeability coefficient of greater than about 1 g/m²d as a 100 micron film at 23° C.

28. A method of preparing a flexible adsorbent body according to claim 20, wherein said polymer comprises at least one of polyether ester, ethylene vinyl acetate, styrene butadiene or ethylene octen polymers.

29. A method of preparing a flexible adsorbent body according to claim 20, wherein said adsorbing material comprises zeolite of the groups 1, 2, 3, 4, 5, 6 and of the A, X and Y families.

30. A method of preparing a flexible adsorbent body according to claim 20, wherein said adsorbing material is present in an amount of about 30 to about 85% by weight of said solid body and said polymer is present in an amount of from about 70 to about 15% by weight of said body.

32. An apparatus for conditioning, separating or purifying gases and liquids comprising:
(a) a monolithic flexible adsorbent body; and
(b) a housing member,
wherein said housing member comprises bent portions comprising said flexible adsorbent body.

33. An apparatus according to claim 32, wherein said body is solid or hollow and comprises a cross-section of an oval, square, rectangle, trefoil, wagon wheel, honeycomb, or film.

34. An apparatus according to claim 32, wherein said flexural modulus of elasticity at 23° C. is about 10 to about 1000 MPa.

35. An apparatus according to claim 32, wherein moisture adsorption capacity of said body at 25° C. and 10% relative humidity comprises at least about 5% by weight water and at least about 30% by weight of said adsorbing material of the total weight of said body.

36. An apparatus according to claim 32, wherein said polymer comprises a permeability coefficient of greater than about 5 g/m²d as a 100 micron film at 23° C.

37. An apparatus according to claim 32, wherein said polymer comprises at least one of polyether ester, ethylene vinyl acetate, styrene butadiene or ethylene octen polymers.

38. An apparatus according to claim 32, wherein said adsorbing material comprises zeolite of the groups 1, 2, 3, 4, 5, 6 and of the A, X and Y families.

39. An apparatus according to claim 32, wherein said adsorbing material is present in an amount of about 30 to about 85% and said polymer is present in an amount of from 70 to about 15% by weight of said body.

40. An apparatus according to claim 32, wherein said apparatus comprises refrigeration devices, chillers or climate systems.

41. An apparatus according to claim 32, wherein said housing member comprises condenser or evaporator tubes.

42. An apparatus according to claim 32, wherein said flexible adsorbent body is inserted into said housing member prior to formation of said bent portions.

43. A method of fabricating an apparatus for conditioning, separating or purifying gases and liquids comprising,
(a) providing a flexible adsorbent body;
(b) providing a housing member; and
(c) modifying the shape of said housing member to form bent portions comprising said flexible adsorbent body.

44. A method according to claim 43, wherein said flexible adsorbent body is inserted into said housing member prior to formation of said bent portions.

45. A method according to claim 43, wherein said apparatus comprises refrigeration devices, chillers or climate systems.

46. A method according to claim 43, wherein said housing member comprises condenser or evaporator tubes.

47. A method according to claim 43, wherein said body is solid or hollow and comprises a cross-section of an oval, square, rectangle, trefoil, wagon wheel, honeycomb, or film.

48. A method according to claim 43, wherein said flexural modulus of elasticity at 23° C. is about 10 to about 1000 MPa.

49. A method according to claim 43, wherein moisture adsorption capacity of said body at 25° C. and 10% relative humidity comprises at least about 5% by weight water and at least about 30% by weight of said adsorbing material of the total weight of said body.

50. A method according to claim 43, wherein said polymer comprises a permeability coefficient of greater than about 5 g/m²d as a 100 micron film at 23° C.

51. A method according to claim 43, wherein said polymer comprises at least one of polyether ester, ethylene vinyl acetate, styrene butadiene or ethylene octen polymers.

52. A method according to claim 43, wherein said adsorbing material comprises zeolite of the groups 1, 2, 3, 4, 5, 6 and of the A, X and Y families.

53. A method according to claim 43, wherein said adsorbing material is present in an amount of about 30 to about 85% and said polymer is present in an amount of from about 70 to about 15% by weight of said body.

54. A flexible desiccant body comprising at least one desiccant incorporated in a polymer matrix, said absorbing material containing the desiccant in an amount of 30 to 85 wt. % (relative to the weight of the absorbing material) and said polymer matrix comprising at least one organic polymer.

55. A flexible desiccant body according to claim 54, wherein the amount of the organic polymer is 70 to 15 wt. % (relative to the weight of the absorbing material).

56. A flexible desiccant body according to claim 54 or 55, wherein the desiccant is selected from activated carbon, activated clays, silica gels, silica-co-gels molecular sieves, in particular from silica gels, zeolites of the groups 1, 2, 3, 4, 5, 6, 7 (according to Donald W Breck) and compositions with iso-type structures, respectively iso-morphous to the aforementioned types of silica gels, silica-co-gels, molecular sieves and any combination thereof.

57. A flexible desiccant body according to claim 56, wherein the zeolites of the groups 1, 2, 3, 4, 5, 6, 7 are selected from members of the zeolite families A, X and Y.

58. A flexible desiccant body according to claim 57, wherein the said zeolite is of the Type 3A.

59. A flexible desiccant body according to any of claims 54 to 57 with a polymer or a blend of polymers with a long-term service temperature range of 40 to 120° C.

60. A flexible desiccant body according to any of claims 54 to 58 with polymer or a blend of polymers with a flexural modulus range at 23° C. from 10 to 1000 MPa.

61. A flexible desiccant body according to any of claims 54 to 59 with a polymer or a blend of polymers with a glass transition temperature of <10° C.

62. A flexible desiccant body according to any of claims 54 to 60 with a polymer or a blend of polymers with a long-term service temperature range of 40 to 120° C.

63. A flexible desiccant body according to any of claims 54 to 61 with a polymer or a blend of polymers with a permeability coefficient (100μ body at 23° C.) in the range from 1 to 500 g/m² d.

64. A flexible desiccant body comprising or consisting of desiccant and polymer as defined in claims 54 to 63 with an equilibrium water adsorption capacity at 25° C. and 10% relative humidity from 5 wt % to 18 wt % depending on the degree of desiccant filling and relative humidity, respectively present moisture concentration in liquids and a corresponding water pick up rate from 0.001 wt %/h@10% relative humidity to 40 wt %/h@80% relative humidity.

65. A flexible desiccant body according to claim 64, which has the shape of a multi-layer film with at least one desiccant layer and one water barrier layer.

66. A method of preparing a flexible desiccant film according to claim 65 comprising following process steps
(a) generating a compound comprising at least one polymer and one desiccant;
(b) using the aforementioned compound as basic material for a flexible desiccant body by means of extrusion applying a flat film extrusion die or a multi-layer co extrusion die, or, alternatively by means of a film blowing device;
(c) coiling the adsorbing flexible body; and
(d) cutting the adsorbing flexible desiccant body.

67. A method of preparing a flexible desiccant film according to claim 66 wherein steps (a) through (d) are performed in a moisture free environment.

68. A method of preparing a flexible desiccant film as defined in claim 66 where compounding and body shaping are executed by applying one apparatus such as a screw extruder with heating, mixing, transportation and pressure-built-up functions and subsequently body shaping by a die, which has been linked to the extruder outlet.

69. A method of preparing a flexible desiccant film as defined in claim 66 where the compounding is executed by a compounding device with melting, mixing and transportation functions prior to the fabrication of intermediate pellets comprising the adsorbing material, whereas compounding and palletising is accomplished in one process step.

70. A method of preparing a flexible desiccant film as defined in claim 66 by processing the intermediate pellets; as defined in claim 16, into a flexible desiccant body using an extruder with a flat body extrusion die, or, alternatively by means of a film blowing device.

71. Use of a flexible desiccant film with a composition as defined by claim 64 and manufactured as defined by claims 66 to 69 for conditioning, separation and purification of gases, vapours and liquids.

72. Use of a flexible desiccant film with a composition as defined by claim 64 and manufactured as defined by claims 66 to 69 in a non-regenerative operating procedure, in particular in the drying of a refrigerant in a closed circulation.

73. Use of a flexible desiccant film with a composition as defined by claim 64 and manufactured as defined by claims 66 to 69 in a non-regenerative operating procedure in particular drying of packed delicate products including bit not limited to moisture sensitive chemical compositions, nutrition and food, drugs, pharmaceuticals, diagnostics and cosmetics, more specifically as desiccants and moisture scavengers in drug bottles and containers, and boxes and cartridges to store and spend diagnostics, and to store spent diagnostics prior to discharge, where the adsorbing flexible desiccant body is placed into or attached to the bottles and containers, and boxes and cartridges, or is integral part of them.

74. Use of a flexible desiccant film with a composition as defined by claim 64 and manufactured as defined by claims 66 to 69 in a non-regenerative operating procedure, in particular moisture protection of non-permanently and permanently packed products such a electronics, optics, opto-electronics as well as micro- and nano-mechanical devices, where the adsorbing flexible desiccant body is placed into or attached to the housing, or is integral part of it.

75. Co-extrusion of a flexible film with at least two layers, one layer consists of an adsorbing material according to claim 54, whereas the other flexible layers have oxygen and moisture barrier properties.

76. Co-extrusion of an adsorbing film or plate with at least two layers, one layer consists of an adsorbing material according to claim 54, the other layers have oxygen and moisture barrier properties and can be coated on an aluminium foil or a paperboard.

77. The Co-extrusion process of claims 75 and 76, which is carried out by means of a co-extrusion flat body die or a co-extrusion film die such as a spiral mandrel head with each layer compound being fed into a separate extruder.

78. Use of the co-extruded flexible film with the double function according to claim 75 for protecting delicate goods according to claim 73 by means of making bags, flexible boxes and other types of flexible containers to be fill with products.

79. Use of the co-extruded flexible film with the double function according to claim 75 for protecting delicate goods according to claim 73 by means of wrapping the products and subsequently sealing.

80. A flexible desiccant body according to claim 54, which has the shape of a bar.

81. A method of preparing a flexible desiccant bar according to claim 80 comprising following process steps
(a) generating a compound comprising at least one polymer and one desiccant;
(b) using the aforementioned compound as basic material for a flexible desiccant body by means of extrusion applying an extrusion or co extrusion die;
(c) coiling the adsorbing flexible desiccant body; and
(d) cutting the adsorbing flexible desiccant body.

82. A method of preparing a flexible desiccant bar according to claim 81 wherein steps (a) through (d) are performed in a moisture free environment.

83. A method of preparing a flexible desiccant bar as defined in claim 81 where compounding and bar shaping are executed by applying one apparatus such as a screw extruder with heating, mixing, transportation and pressure-built-up functions and subsequently bar shaping by a die, which has been linked to the extruder outlet.

84. A method of preparing a flexible desiccant bar as defined in claim 83 where the compounding is executed by a compounding device with melting, mixing and transportation functions prior to the fabrication of intermediate pellets comprising the adsorbing material, whereas compounding and palletising is accomplished in one process step.

85. A method of preparing a flexible desiccant bar as defined in claim 81 by processing the intermediate pellets, as defined in claim 69, into a flexible desiccant bar using an extruder with a round extrusion die.

86. A method of preparing a flexible desiccant bar as defined in claims 81 where the die allows to extrude bars with cross sections of oval, squared, rectangle, trefoil, wagon wheel, honeycomb or any other shapes.

87. Use of a flexible desiccant bar with a composition as defined by claim 81 for conditioning, separation and purification of gases, vapours and liquids.

88. Use of a flexible desiccant bar with a composition as defined by claim 81 in a non-regenerative operating procedure, in particular in the drying of a refrigerant in a closed circulation.

89. Use of a flexible desiccant bar according to claim 87 and preferably furnished with the adsorbents zeolite 3A and zeolite 4A as agents for the drying of a refrigerant in a closed circulation.

90. Use of a flexible desiccant bar according to claim 87 where the bar can directly be positioned in the condenser tube prior to the meander-shape bending.

91. Use of a flexible desiccant bar according to 90 where the bar can directly be positioned in the condenser tube after the meander-shape bending.

92. Use of an flexible desiccant bar manufactured as defined by claims 81 in a non-regenerative operating procedure in particular drying of packed delicate products including bit not limited to moisture sensitive chemical compositions, nutrition and food, drugs, pharmaceuticals, diagnostics and cosmetics, more specifically as desiccants and moisture scavengers in drug bottles and containers, and boxes and cartridges to store and spend diagnostics, and to store spent diagnostics prior to discharge, where the flexible desiccant bar is placed into or attached to the bottles and containers, and boxes and cartridges, or is integral part of them.

93. Use of an flexible desiccant bar manufactured as defined by claim 81 in a non-regenerative operating procedure, in particular moisture protection of non-permanently and permanently packed products such a electronics, optics, opto-electronics as well as micro- and nano-mechanical devices, where the flexible desiccant bar is placed into or attached to the housing, or is integral part of it.

94. A flexible desiccant body according to claim 54, which has any arbitrary shape that can be manufactured by means of injection moulding and/or press moulding.

95. A method of preparing a flexible desiccant body according to claim 94 comprising the following process steps
(a) generating a compound comprising at least one polymer and one desiccant; and
(b) using the aforementioned compound as basic material for a flexible desiccant body by means of injection moulding and/or press moulding.

96. A method of preparing a flexible desiccant body according to claim 95 wherein steps (a) through (b) are performed in a moisture free environment.

97. Use of a flexible desiccant body manufactured as defined by claims 95 and 96 in a non-regenerative operating procedure, in particular in the drying of a refrigerant in a closed circulation.

98. Use of a flexible desiccant body according to 94 and preferably furnished with the adsorbents zeolite 3A and zeolite 4A as agents for the drying of a refrigerant in a closed circulation.

99. Use of an flexible desiccant body manufactured as defined by claims 95 and 96 in a non-regenerative operating procedure in particular drying of packed delicate products including bit not limited to moisture sensitive chemical compositions, nutrition and food, drugs, pharmaceuticals, diagnostics and cosmetics, more specifically as desiccants and moisture scavengers in drug bottles and containers, and boxes and cartridges to store and spend diagnostics, and to store spent diagnostics prior to discharge, where the flexible desiccant body is placed into or attached to the bottles and containers, and boxes and cartridges, or is integral part of them.

100. Use of an flexible desiccant body manufactured as defined by claims 95 and 96 in a non-regenerative operating procedure, in particular moisture protection of non-permanently and permanently packed products such a electronics, optics, opto-electronics as well as micro- and nano-mechanical devices, where the flexible desiccant body is placed into or attached to the housing, or is integral part of it.
